(19) United States
(12) Patent Application Publication
(10) Pub. No.: US 2014/0368360 A1
(43) Pub. Date: Dec. 18, 2014

(54) ELECTRONIC SYSTEM FOR TRACKING AND MONITORING MOTORCYCLE RACE

(71) Applicant: HON HAI PRECISION INDUSTRY CO., LTD., New Taipei (TW)

(72) Inventors: PENG-ZHENG YANG, New Taipei (TW); YI-MING CHANG, New Taipei (TW); TENG-SHENG YU, New Taipei (TW)

(21) Appl. No.: 14/302,945

(22) Filed: Jun. 12, 2014

(30) Foreign Application Priority Data
Jun. 14, 2013 (TW) 102121031

(51) Int. Cl. A63K 3/00; G08G 1/127

(52) U.S. Cl. CPC A63K 3/00; G08G 1/127
USPC 340/989

(57) ABSTRACT

A travelling data recorder includes an input unit for generating a first input instruction to issue a challenge to a race, a recognition unit for recognizing the generated first instruction, a location-detection unit for obtaining real-time location of a participating motor vehicle during running of the race. Also included are a motion-data collection unit for obtaining real-time motion data of the motor vehicle during running of the race, an identification unit for identifying identity the motor vehicle, and a microprocessor for controlling the transmissions of the recognized instruction, the obtained real-time location and the real-time motion data, and the identification of the motor vehicle to a server and the travelling data recorder receiving the result of the race from the server.

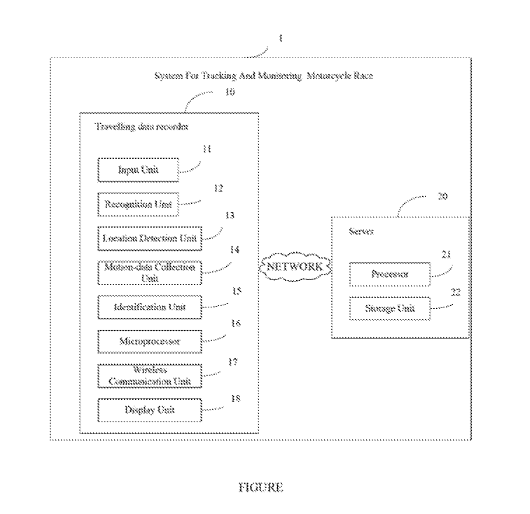

### FIELD

The subject matter herein generally relates to a electronic system for tracking and monitoring moving vehicles and a travelling data recorder.

### BACKGROUND

A travelling data recorder is used for recording travelling information of a vehicle. The recorded travelling information can be speed, time elapsed, mileage, and statuses of components of the vehicle. The travelling data recorder also warns the driver when the speed of the vehicle is faster than a preset value, and displays speed and/or mileage information to the driver.

### BRIEF DESCRIPTION OF THE DRAWINGS

Implementations of the present technology will now be described, by way of example only, with reference to the attached figure, wherein:

The figure is a block diagram of a system for tracking and monitoring moving vehicles (for example, a motorcycle race).

### DETAILED DESCRIPTION

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawing is not necessarily to scale and the proportions of certain parts may have been exaggerated to better illustrate details and features of the present disclosure.

Several definitions that apply throughout this disclosure will now be presented.

The term “comprising” when utilized, means “including, but not necessarily limited to”; it specifically indicates open-ended inclusion or membership in the so-described combination, group, series and the like.

The figure illustrates a system 1 for tracking and monitoring motorcycle races. The system 1 comprises a travelling data recorder 10 and a server 20. The travelling data recorder 10 is wirelessly connected to the server 20 for transmitting data via wireless network such as Wireless Fidelity (Wi-Fi) or Global System for Mobile Communication (GSM).

The travelling data recorder 10 is installed on a motorcycle (not shown in figure). In at least one embodiment, the travelling data recorder 10 can be installed under a seat of the motorcycle or on a wheel axle of the motorcycle. Typically, one motorcycle can receive only one travelling data recorder 10. The travelling data recorder 10 comprises an input unit 11, a recognition unit 12, a location-detection unit 13, a motion-data collection unit 14, an identification unit 15, a microprocessor 16, and a wireless communication unit 17.

The input unit 11 generates a first instruction to issue a challenge to a motorcycle race in response to a first input operation. The input unit 11 also generates other instructions such as to launch a new race or to view the result of a previous motorcycle race. Different instructions are associated with different input operations. The recognition unit 12 recognizes the instructions generated by the input unit 11. When the recognition unit 12 recognizes a first instruction to issue a challenge to a motorcycle race, the location-detection unit 13 detects a real-time location of the motorcycle, and the motion-data collection unit 14 collects real-time motion data of the motorcycle during the race, the identification unit 15 determines an identity of the motorcycle. The identity of the motorcycle comprises brand, model, and owner or rider name of the motorcycle. The microprocessor 16 causes transmission of the recognized instruction, the detected real-time location and the collected real-time motion data, and the identity to the server 20 via the wireless communication unit 17.

The server 20 comprises a processor 21. The processor 21 calculates a result of a race according to the detected real-time location, the collected real-time motion data, and the identity of the motorcycle.

The travelling data recorder 10 further comprises a display unit 18. The processor 21 further transmits the result of the race to the travelling data recorder 10. The microprocessor 16 controls the display unit 18 to display the result of the race transmitted from the server 20.

The input unit 11 further generates a second instruction to launch a new race in response to a second input operation. The processor 21 launches the new race in response to the second instruction. In at least one embodiment, the processor 21 determines whether the new race that a user wants to launch is being recorded in the server 20. When the new race is not being recorded in the server 20, the processor 21 launches the race in response to operations of the user. When the race that a user wants to launch is to be recorded in the server 20, the processor 21 obtains information of the race, and transmits the obtained information to the travelling data recorder 10, so the user can follow the race from display unit 18 of the travelling data recorder 10.

The server 20 further comprises a storage unit 22 for storing results of each of the races and results of each challenge racer in a race. The input unit 11 generates a third instruction to view the result of the racer in the race in response to the third input operation. The processor 21 obtains the result of a racer in a race from the storage unit 22 in response to the third instruction generated by the input unit 11.

In at least one embodiment, when there are more than one racer in a single race, the processor 21 ranks the results of all racers participating in the single race and transmits the rank to the travelling data recorder 10.

In at least one embodiment, the location of a motorcycle collected by the location-detection unit 13 comprises longitude, latitude, and altitude of the motorcycle during the race. The location-detection unit 13 is a GPS sensor. In an alternative embodiment, the location-detection unit 13 is a Wi-Fi Positioning System (WPS) sensor.

The motion data of the motorcycle collected by the motion-data collection unit 14 comprises an average speed of the motorcycle and instantaneous speeds of the motorcycle during the race. The motion-data collection unit 14 is a speed sensor.

Although the present disclosure has been described with reference to certain embodiments, persons having ordinary skill in the art may make various modifications and changes without departing from the scope of the disclosure. Therefore, the scope of the appended claims should not be limited to the description of the embodiments described above.

What is claimed is:

1. A system for tracking and monitoring mobile vehicles, the system comprising:
a data recorder installed on a mobile vehicle, the travelling data recorder comprising:
an input unit configured to generate a first instruction to issue a challenge to a race in response to a first input operation;
a recognition unit configured to recognize the generated first instruction;
a location-detection unit configured to detect a real-time location of the mobile vehicle during a race;
a motion-data collection unit configured to collect real-time motion data of the mobile vehicle during the race; and
an identification unit configured to identify the identity of the mobile vehicle; and
a server in signal communication with the travelling data recorder, the server comprising a processor configured to:
receive the recognized instruction, the detected real-time location, the collected real-time motion data, and the identity of the mobile vehicle transmitted from the travelling data recorder, and further configured to calculate a result of the race according to the detected real-time location, the collected real-time motion data, and the identity of the mobile vehicle.

2. The system as described in claim 1, wherein the travelling data recorder further comprises a display unit and a microprocessor, the processor further transmits the result of the race to the travelling data recorder, and the microprocessor controls the display unit to display the result of the race.

3. The system as described in claim 2, wherein the input unit generates a second instruction to launch a new race in response to a second input operation, the processor launches the new race in response to the second instruction.

4. The system as described in claim 3, wherein the processor is also configured to determine whether the new race to be launched in response to the second instruction is being recorded in the server, and to launch the new race in response to the second instruction when the new race is not being recorded in the server.

5. The system as described in claim 4, wherein the server further comprises a storage unit storing results of each of races, the input unit generates a third instruction to view the result of a racer in a race in response to a third input operation, and the processor obtains the result of the racer from the storage unit in response to the third instruction.

6. The system as described in claim 4, wherein the processor ranks the result of a racer in a race and transmits the results of the racer and the rank of the result to the travelling data recorder.

7. The system as described in claim 4, wherein the identity of the motor vehicle comprises brand, style and owner or rider name of the motor vehicle.

8. A travelling data recorder comprising:
an input unit configured to generate a first input instruction to issue a challenge to a race in response to a first input operation;
a recognition unit configured to recognize the generated first instruction;
a location-detection unit configured to detect real-time location of the motor vehicle;
a motion-data collection unit configured to collect real-time motion data of the motor vehicle during a race;
an identification unit configured to identify the identity of the motor vehicle; and
a microprocessor for controlling to transmit the recognized instruction, the detected real-time location and the collected real-time motion data, and the identified identity of the motor vehicle to an server wirelessly and to receive the result of the race from the server through network, and the result of the race calculated by the server according to the detected real-time location, and the collected real-time motion data.

9. The travelling data recorder as described in claim 8, wherein the location of the motor vehicle comprises longitude, latitude, and altitude of the motor vehicle during the race.

10. The travelling data recorder as described in claim 9, wherein the location-detection unit is a GPS sensor.

11. The travelling data recorder as described in claim 8, wherein the motion data of the motor vehicle comprises average speeds of the motor vehicle and instantaneous speeds of the motor vehicle during the running of a race event.

12. The travelling data recorder as described in claim 10, wherein the motion-data collection unit is a speed sensor.
